(19) United States
(12) Patent Application Publication
(10) Pub. No.: US 2015/0295710 A1
(43) Pub. Date: Oct. 15, 2015

(54) PAILLIER-BASED BLIND DECRYPTION METHODS AND DEVICES

(71) Applicant: THOMSON LICENSING, Issy de Moulineaux (FR)

(72) Inventors: Marc JOYE, Fougeres (FR); Benoit LIBERT, Cesson Sevigne (FR)

(21) Appl. No.: 14/679,109

(22) Filed: Apr. 6, 2015

(30) Foreign Application Priority Data
Apr. 11, 2014 (EP) 14305536.6

(51) Int. Cl. H04L 9/30; H04L 9/00

(52) U.S. Cl. CPC H04L 9/3006; H04L 9/008

(57) ABSTRACT

Paillier-based blind decryption. A user device obtains a first Paillier Paillier ciphertext c for a message m, generates a blinded Paillier ciphertext c₀ by calculating c₀=c mod N, sends the blinded Paillier ciphertext c₀ to a decryptor and generates a first value [symbol] ₀=c₀⁻¹ mod N and a blinded plaintext

$${m}^{*} = \frac{( c {ϱ}_{0} mod {N}^{2} ) - 1}{N} .$$

The decryptor generates a first key λ₀ from a private key λ, generates a second value ρ₀=c₀^{λ}^{₀} mod N, generates a third value [symbol] =Σ₀^{N} mod N² and, finally, generates a return value

$${μ}_{1} = \frac{( {ϱc}_{0} mod {N}^{2} ) - 1}{N}$$

that is returned to the user device, which calculates the clear plaintext m=m*+μ₁ mod N. The clear plaintext m can then for example be output to a user or stored for later retrieval. Also provided is a generalized Paillier-based blind decryption.

### TECHNICAL FIELD

The present disclosure relates generally to cryptography, and in particular to blind decryption in public-key cryptosystems.

### BACKGROUND

This section is intended to introduce the reader to various aspects of art, which may be related to various aspects of the present disclosure that are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

In 1999 Pascal Paillier proposed a new public-key cryptosystem [Pascal Paillier. Public-key cryptosystems based on composite degree residuosity classes. In Jacques Stern, editor, Advances in Cryptology—EUROCRYPT '99, volume 1592 of Lecture Notes in Computer Science, pages 223-238. Springer, 1999], which was later generalized by Damgård and Jurik [Ivan Damgård and Mads Jurik. A generalisation, a simplification and some applications of Paillier's probabilistic public-key system. In Kwangjo Kim, editor, Public Key Cryptography, volume 1992 of Lecture Notes in Computer Science, pages 119-136. Springer, 2001] and which can be described as follows:

Let an integer s≧1. Let also two (large) primes p and q and let N=pq. The public key is {N,s} and the private key is λ=lcm(p−1, q−1). The message space is [symbol] = [symbol] /N^{s} [symbol] . The encryption of a message m∈ [symbol] is given by

c=(1+N)^{m}r^{N}^{^{s}} mod N^{s+1}

for some random element r drawn in ( [symbol] /N^{s+1} [symbol] )* where ( [symbol] /N^{s+1} [symbol] )* denotes the multiplicative group of the ring of integers modulo N^{s+1}, [symbol] /N^{s+1} [symbol] .

The encryption is decrypted inductively using λ from

$${c}^{λ} ≡ {( 1 + N )}^{mλ} {r}^{λ {N}^{s}} ≡ {( 1 + N )}^{mλ} ≡ {( 1 + N )}^{( λ {\sum }_{i = 0}^{s - 1} {m}_{i} {N}^{i} ) mod {N}^{s}} ( mod {N}^{s + 1} ) \qquad ( 1 )$$

where m=Σᵢ₌₀^{s-1}mᵢNⁱ and mᵢ∈ [symbol] /N [symbol] . The following relation is used (130 N)^{αN}^{^{s−1}}≡1+αN^{s} (mod N^{s+1}) for any α∈ [symbol] .

Hence, letting Cᵢ=c^{λ} mod Nⁱ⁺², for 0≦i≦s−1, and defining function Lₖ: [symbol] →

[symbol]

$$x ↦ {L}_{k} ( x ) = \frac{x - 1}{{N}^{k}} ,$$

equation gives

$${C}_{0} ≡ {( 1 + N )}^{( λ {m}_{0} ) mod N} ≡ 1 + ( λ {m}_{0} mod N ) N ( mod {N}^{2} ) ⇒ {m}_{0} = \frac{{L}_{1} ( {C}_{0} )}{λ} mod N$$

$${C}_{1} ≡ {( 1 + N )}^{( λ {m}_{0} + λ {m}_{1} N ) mod {N}^{2}} ≡ {( 1 + N )}^{λ {m}_{0}} {( 1 + N )}^{N ( λ {m}_{1} mod N )} ≡ {( 1 + N )}^{λ {m}_{0}} ( 1 + ( λ {m}_{1} mod N ) {N}^{2} ) ( mod {N}^{3} ) ⇒ {m}_{1} = \frac{{L}_{2} ( {D}_{1} )}{λ} mod N ,$$

with

$${D}_{1} = \frac{{C}_{1}}{{( 1 + N )}^{λ {m}_{0}}} mod {N}^{3}$$

and expressed more generally

$${C}_{i} ≡ {( 1 + N )}^{( λ {m}_{0} + … + λ {m}_{i} {N}^{i} ) mod {N}^{i + 1}} ≡ {( 1 + N )}^{λ ( {\sum }_{j = 0}^{i - 1} {m}_{j} {N}^{j} )} {( 1 + N )}^{{N}^{i} ( λ {m}_{i} mod N )} ≡ {( 1 + N )}^{λ ( {\sum }_{j = 0}^{i - 1} {m}_{j} {N}^{j} )} ( 1 + ( λ {m}_{i} mod N ) {N}^{i + 1} ( mod {N}^{i + 2} ) ⇒ {m}_{i} = \frac{{L}_{i + 1} ( {D}_{i} )}{λ} mod N ,$$

with

$${D}_{i} = \frac{{C}_{i}}{{( 1 + N )}^{λ ( {\sum }_{j = 0}^{i - 1} {m}_{j} {N}^{j} )}} mod {N}^{i + 2} .$$

In a number of applications, it is required that the owner of the private decryption key λ, called the decryptor, learns no information about a given plaintext.

In such a setting, a user wishing to get the decryption of a given ciphertext (encrypted under the decryptor's public-key) blinds the ciphertext. In more detail, if c denotes the ciphertext, the user chooses at random an element μ∈ [symbol] and computes the blinded ciphertext

c*=c(1+N)^{μ} mod N^{s+1}.

Upon receiving the blinded ciphertext c*, the decryptor decrypts it and obtains a blinded message m*=m+μ (in [symbol] ). The decryptor sends m* to the user. As the user knows the mask μ (chosen by the user), the user can recover the plaintext corresponding to ciphertext c as m=m*−μ(mod N^{s+1}).

It will be appreciated that the above protocol wastes bandwidth. If [symbol] (N) is the bit-length of N (typically 2048 or more), the communication between the user and the decryptor incurs an exchange of

(s+1)· [symbol] (N)+s· [symbol] (N)=(2S+1) [symbol] (N)

bits.

It will be appreciated that it is desired to have a technique that allows to decrease this quantity. It would also be good to have a technique that is faster, in terms of computation, for both the user and the decryptor.

The present disclosure provides such a technique.

### SUMMARY

In a first aspect, the disclosure is directed to a cryptographic device comprising: an interface configured to send a blinded Paillier ciphertext c₀ to a decryption device and to receive a return value μ₁ from the decryption device; and a processor configured to: obtain a Paillier ciphertext c, the Paillier ciphertext c having been generated using an encryption method with a public key comprising a modulus N being the product of at least two primes p, q; calculate the blinded Paillier ciphertext c₀ by taking the Paillier ciphertext c modulo a value based on the modulus N; calculate a first value [symbol] ₀ through a calculation involving an inverse of the blinded Paillier ciphertext c₀ modulo a value based on the modulus N; generate a blinded plaintext m* through a calculation involving a multiplication of the Paillier ciphertext c and the first value [symbol] ₀; and generate a plaintext m through a calculation involving an addition of the blinded plaintext m* and the return value μ₁ modulo a value based on the modulus N.

In a second aspect, the disclosure is directed to a decryption device comprising: an interface configured to receive a blinded Paillier ciphertext c₀ from a cryptographic device and to send a return value μ₁ to the cryptographic device; and a processor configured to: calculate a first key λ₁ through a calculation involving an inversion of a modulus N modulo a value based on a private key λ; calculate a second value ρ₀ through a calculation involving the blinded Paillier ciphertext c₀ to the power of the first key λ₀ modulo a value based on the modulus N; calculate a third value [symbol] through a calculation involving the second value ρ₀ to the power of the modulus N modulo a value based on the modulus N; and calculate the return value μ₁ through a calculation involving a multiplication of the third value [symbol] and the blinded Paillier ciphertext c₀.

In a third aspect, the disclosure is directed to a cryptographic device comprising: an interface configured to send a blinded Paillier ciphertext c₀ to a decryption device and to receive at least one return value from the decryption device; and a processor configured to: obtain a Paillier ciphertext c, the Paillier ciphertext c having been generated using an encryption method with a public key comprising a modulus N being the product of at least two primes p, q; calculate the blinded Paillier ciphertext c₀ by taking the Paillier ciphertext c modulo a value based on the modulus N; calculate a first value [symbol] ₀ through a calculation involving an inverse of the blinded Paillier ciphertext c₀ modulo a value based on the modulus N; obtain a third value [symbol] from the at least one return value; calculate an exponent value (1+N)^{m} modulo a value based on the modulus N through a calculation involving a multiplication between the Paillier ciphertext c and the third value [symbol] ; and obtain a plaintext m from the exponent value (1+N)^{m} modulo a value based on the modulus N using inductive decryption.

In a fourth aspect, the disclosure is directed to a decryption device comprising: an interface configured to receive a blinded Paillier ciphertext c₀ from a cryptographic device and to send at least one return value to the cryptographic device; and a processor configured to: calculate a first key λ₀ through a calculation involving an inversion of a modulus N to the power of a value s having been used to generate a Paillier ciphertext c from which the blinded Paillier ciphertext c₀ was calculated, the inversion being taken modulo a value based on a private key λ; calculate a second value ρ₀ through a calculation involving the blinded Paillier ciphertext c₀ to the power of the first key λ₀ modulo a value based on the modulus N; calculate a third value [symbol] through a calculation involving the second value ρ₀ to the power of the modulus N to the power of the value s modulo a value based on the modulus N and the value s, the third value; and obtain the at least one return value, the return value being equal to the third value [symbol] or a value based on the third value [symbol] minus a first component [symbol] ₀ and the modulus N, the first component [symbol] ₀ being equal to a value obtained by a calculation involving an inverse of the blinded Paillier ciphertext c₀ modulo a value based on the modulus N.

In a fifth aspect, the disclosure is directed to a cryptographic method for generating a plaintext m for a Paillier ciphertext c, the method comprising, in a device comprising a processor: obtaining a Paillier ciphertext c, the Paillier ciphertext c having been generated using an encryption method with a public key comprising a modulus N being the product of at least two primes p, q; calculating a blinded Paillier ciphertext c₀ by taking the Paillier ciphertext c modulo a value based on the modulus N; calculating a first value [symbol] ₀ through a calculation involving an inverse of the blinded Paillier ciphertext c₀ modulo a value based on the modulus N; generating a blinded plaintext m* through a calculation involving a multiplication of the Paillier ciphertext c and the first value [symbol] ₀; and generating the plaintext m through a calculation involving an addition of the blinded plaintext m* and the return value μ₁ modulo a value based on the modulus N.

In a sixth aspect, the disclosure is directed to a cryptographic method for blind decryption of a blinded Paillier ciphertext c₀, the method comprising, in a device comprising a processor: obtaining a first key λ₀, the first key λ₀ having been generated through a calculation involving an inversion of a modulus N modulo a value based on a private key λ; calculating a second value ρ₀ through a calculation involving the blinded Paillier ciphertext c₀ to the power of the first key λ₀ modulo a value based on the modulus N; calculating a third value [symbol] through a calculation involving the second value ρ₀ to the power of the modulus N modulo a value based on the modulus N; calculating a return value μ₁ through a calculation involving a multiplication of the third value [symbol] and the blinded Paillier ciphertext c₀; and outputting the return value μ₁.

In a seventh aspect, the disclosure is directed to a cryptographic method for generating a plaintext m for a Paillier ciphertext c, the method comprising, in a device comprising a processor: obtaining the Paillier ciphertext c, the Paillier ciphertext c having been generated using an encryption method with a public key comprising a modulus N being the product of at least two primes p, q; calculating the blinded Paillier ciphertext c₀ by taking the Paillier ciphertext c modulo a value based on the modulus N; calculating a first value [symbol] ₀ through a calculation involving an inverse of the blinded Paillier ciphertext c₀ modulo a value based on the modulus N; obtaining a third value [symbol] from the at least one return value; calculating an exponent value (1+N)^{m} modulo a value based on the modulus N through a calculation involving a multiplication between the Paillier ciphertext c and the third value [symbol] ; and obtaining the plaintext m from the exponent value (1+N)^{m} modulo a value based on the modulus N using inductive decryption.

In an eighth aspect, the disclosure is directed to a cryptographic method for blind decryption of a blinded Paillier ciphertext c₀, the method comprising, in a device comprising a processor: obtaining a first key λ₀, the first key λ₀ having been generated through a calculation involving an inversion of a modulus N to the power of a value s having been used to generate a Paillier ciphertext c from which the blinded Paillier ciphertext c₀ was calculated, the inversion being taken modulo a value based on a private key λ; calculating a second value ρ₀ through a calculation involving the blinded Paillier ciphertext c₀ to the power of the first key λ₀ modulo a value based on the modulus N; calculating a third value [symbol] through a calculation involving the second value ρ₀ to the power of the modulus N to the power of the value s modulo a value based on the modulus N and the value s; obtaining the at least one return value, the return value being equal to the third value [symbol] or a value based on the third value [symbol] minus a first component [symbol] ₀ and the modulus N, the first component [symbol] ₀ being equal to a value obtained by a calculation involving an inverse of the blinded Paillier ciphertext c₀ modulo a value based on the modulus N; and outputting the at least one return value.

### BRIEF DESCRIPTION OF DRAWINGS

Preferred features of the present disclosure will now be described, by way of non-limiting example, with reference to the accompanying drawings, in which:

FIG. 1 illustrates a blind Paillier decryption system and method according to a preferred embodiment; and

FIG. 2 illustrates a system and a method for generalized Paillier decryption.

### DESCRIPTION OF EMBODIMENTS

First it is observed that for any r∈( [symbol] /N^{s+1} [symbol] )*,

r^{N}^{^{s}}≡(r mod N)^{N}^{^{s}}(mod N^{s+1}). (2)

Proof. For any integer α, an application of the binomial identity immediately yields

(r+αN)^{N}^{^{s}}≡Σⱼ₌₀^{N}^{^{s}}(ⱼ^{N}^{^{s}})r^{N}^{^{s}}^{-j}(αN) ^{j}≡r^{N}^{^{s}}+Σⱼ₌₁^{s}(ⱼ^{N}^{^{s}})r^{N}^{^{s}}^{-j}(αN)^{j}≡r^{N}^{^{s}}(mod N^{s+1}). □

As a result, the decryption of a ciphertext c can be decrypted in two steps as:

1. ρ₀=c₀^{λ}^{₀} mod N, where λ₀=−N^{-s} mod λand c₀=c mod N;

2. c ρ₀^{N}^{^{s}}≡(1+N)^{m} (mod N^{s+1}) from which m is obtained. This will be described further hereinafter as it depends on the embodiment.

Defining [symbol] =ρ₀^{N}^{^{s}} mod N^{s+1} and using equation (2), since ρ₀≡r⁻¹ mod N, it is possible to write [symbol] =r^{-N}^{^{s}} mod N^{s+1}=Σᵢ₌₀^{s} [symbol] ᵢNⁱ with 0≦ [symbol] ≦N−1. It should also be noted that [symbol] ₀=c₀⁻¹ mod N.

The Paillier cryptosystem corresponds to the case s=1. Hence, letting μᵢ= [symbol] ᵢ/ [symbol] ₀ mod N gives [symbol] = [symbol] ₀(1+μ₁N), whence

c [symbol] ≡c [symbol] ₀(1+μ₁N)≡(1+mN)(mod N²) [symbol] c [symbol] ₀≡(1+(m−μ₁)N)(mod N²)

and thus

$$m - {μ}_{1} mod N = \frac{( {cϱ}_{0} mod {N}^{2} ) - 1}{N} .$$

From the sole knowledge of c, the user can therefore compute

$${m}^{*} := m - {μ}_{1} mod N = \frac{( {cϱ}_{0} mod {N}^{2} ) - 1}{N} with {0}_{} = {c}_{0}^{- 1} mod N .$$

Likewise, from the sole knowledge of c₀, the decryptor can compute

$${μ}_{1} = \frac{{1}_{}}{{0}_{}} mod N with ϱ = {ρ}_{o}^{N} mod {N}^{2} = {1}_{} N + {ϱ}_{0} .$$

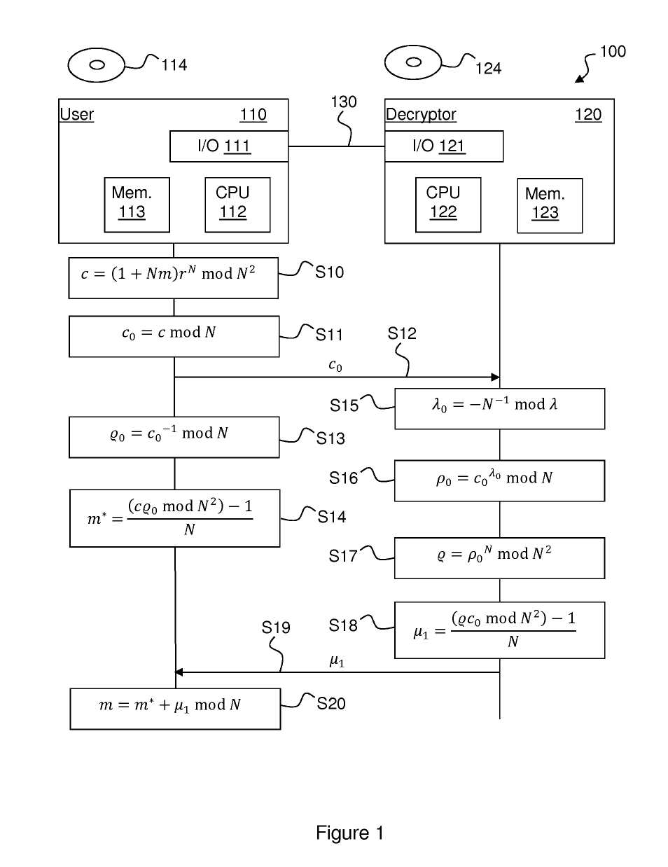

It is worth noting that the value of c₀ leaks no information on message m. The user thus ends up having m*=m−μ₁ mod N and the decryptor having μ₁. This is depicted in FIG. 1 hereinafter.

FIG. 1 illustrates a method for blind Paillier decryption according to the present disclosure. FIG. 1 shows a system 100 comprising a user device 110 and a decryption device 120 (“decryptor”). Each device 110, 120 comprises an interface 111, 121 configured for communication with the other device, at least one processor (“CPU”) 112, 122 and memory 113, 123. The devices also comprise other necessary hardware and software components such as internal connections, but these are not shown to simplify the illustration. Also shown are a first non-transitory computer program storage medium 114 and a second non-transitory computer program storage medium 116 that store instruction that, when executed by a processor, respectively perform the methods of the user device 110 and the decryptor 120 described hereinafter.

The user device 110 obtains S10 a first ciphertext c for a message m from some external device that has calculated it using Paillier encryption: c=(1+mN)r^{N} mod N², wherein r is a random number and N is a RSA-type modulus. The user device 110 then generates S11 a blinded ciphertext c₀ by calculating c₀=c mod N and sends S12 the blinded ciphertext c₀ to the decryptor 120 over a connection 130.

The user device 110 then, advantageously while waiting for a response from the decryptor 120, generates S13 a first value by calculating [symbol] ₀=c₀⁻¹ mod N and then generates a blinded plaintext by calculating

$${m}^{*} = \frac{( c {0}_{} mod {N}^{2} ) - 1}{N} .$$

Upon reception of the blinded ciphertext c₀, the decryptor 120 generates S15 a first key λ₀ from a private key λ by calculating λ₀=−N⁻¹ mod λ, generates S16 a second value by calculating ρ₀=c₀^{λ}^{₀} mod N, generates S17 a third value by calculating [symbol] =ρ₀^{N} mod N² and, finally, generates S18 a return value μ₁ by calculating

$${μ}_{1} = \frac{( {ϱc}_{0} mod {N}^{2} ) - 1}{N} .$$

The decryptor 120 returns S19 the return value μ₁ to the user device 110.

Upon reception of the return value μ₁, the user device 110 calculates S20 the clear plaintext by calculating m=m*30 μ₁ mod N. The clear plaintext m can then for example be output to a user or stored for later retrieval.

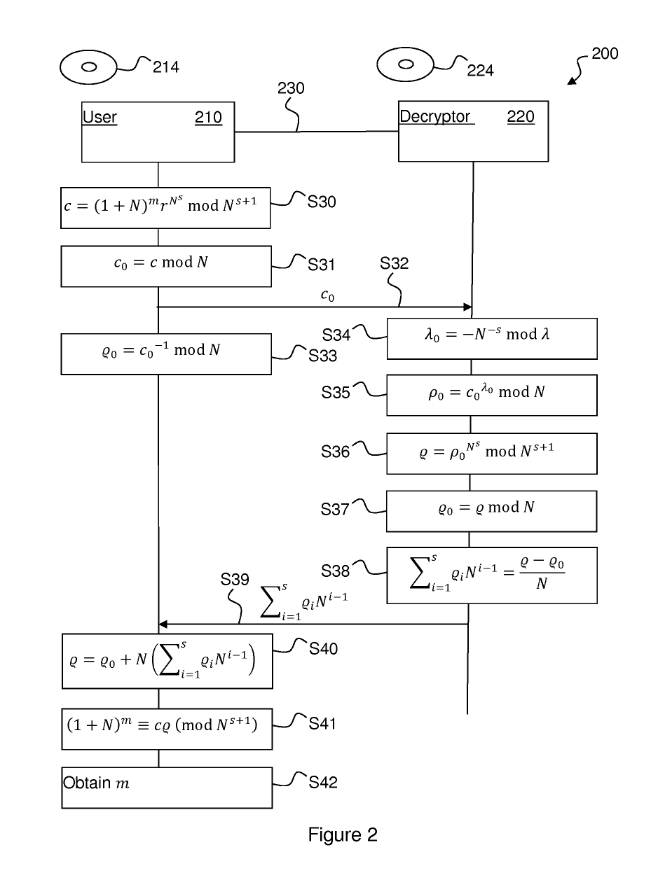

The technique can be generalized to the case s≧1; the expected relative gain then becomes (s+1)/s. The technique is illustrated in FIG. 2. The Figure illustrates a simplified version of the user device 210 and the decryptor 220, but it is to be understood that these devices comprise the necessary hardware and software components, essentially those illustrated for the devices in FIG. 1. FIG. 2 also illustrates a third non-transitory computer program storage medium 214 and a fourth non-transitory computer program storage medium 216 that store instruction that, when executed by a processor, respectively perform the methods of the user device 210 and the decryptor 220 described hereinafter.

The user device 210 obtains S30 a first ciphertext c for a message m from some external device that has calculated it using Paillier encryption: c=(1+mN)r^{N}^{^{s}} mod N^{s+1}, wherein r is a random number and N is an RSA-type modulus. The user device 210 then generates S31 a blinded ciphertext c₀ by calculating c₀=c mod N as in FIG. 1 and sends S32 the blinded ciphertext c₀ to the decryptor 220 over a connection 230.

The user device 210 then, advantageously while waiting for a response from the decryptor 220, generates S33 a first value by calculating [symbol] ₀=c₀⁻¹ mod N.

Upon reception of the blinded ciphertext c₀, the decryptor 220 generates S34 a first key λ₀ from a private key λ by calculating λ₀=−N^{-s} mod λ, generates S35 a second value by calculating ρ₀=c₀^{λ}^{₀} mod N, generates S36 a third value by calculating [symbol] =ρ₀^{N}^{^{s}} mod N^{s+1}, generates S37 a fourth value by calculating [symbol] ₀= [symbol] mod N and, finally, generates S38 a return value by calculating

$$\frac{ϱ - {ϱ}_{0}}{N}$$

or equivalently [symbol] ₁, . . . , [symbol] ₛ and sends S39 this value or these values to the user device 210. It is noted that it is possible to view [symbol] as an integer in base N, i.e. [symbol] =Σᵢ₌₀^{s} [symbol] ᵢNⁱ⁻¹.

The user device 210 recovers S40 [symbol] from [symbol] ₁, . . . [symbol] ₛ from [symbol] ₀=c₀⁻¹ mod N. The user device 210 then calculates S41 c [symbol] (mod N^{s+1}) to obtain

(1+N)^{m} mod N^{s+1}.

It then remains to obtain m from Y:=(1+N)^{m} mod N^{s+1}. Let m=Σᵢ₌₀^{s}mᵢNⁱ with mᵢ∈ [symbol] /N [symbol] . Define Yᵢ=Y mod Nⁱ⁺², for 0≦i≦s−1. Then:

Y₀≡(1+N)^{m}^{₀}≡(1+m₀N)(mod N²) [symbol] m₀=L₁(Y₀)

Y₁≡(1+N)^{m}^{₀}^{+m}^{₁}^{N}≡(1+N)^{m}^{₀}(1+m₁N²)(mod N³) [symbol] m₁=L₂(Z₁)

with

$${Z}_{1} = \frac{{Y}_{1}}{{( 1 + N )}^{{m}_{0}}} mod {N}^{3}$$

$${Y}_{i} ≡ {( 1 + N )}^{{\sum }_{j = 0}^{i} {m}_{j} {N}^{j}} ≡ {( 1 + N )}^{{\sum }_{j = 0}^{i - 1} {m}_{j} {N}^{j}} ( 1 + {m}_{i} {N}^{i + 1} ) ( mod {N}^{i + 2} ) ⇒ {m}_{i} = {L}_{i + 1} ( {Z}_{i} )$$

with

$${Z}_{i} = \frac{{Y}_{i}}{{( 1 + N )}^{{\sum }_{j = 0}^{i - 1} {m}_{j} {N}^{j}}} mod {N}^{i + 2}$$

The clear plaintext m can then for example be output to a user or stored for later retrieval.

In the generalization, with s=1 (i.e., based on the original Paillier cryptosystem), the user device 210 and the decryptor 220 exchange c₀ and [symbol] ₁. Upon receiving [symbol] ₁, the user device computes c( [symbol] ₀+N [symbol] ₁) mod N² and gets (1+N)^{m}≡1+mN (mod N²) from which m is obtained; namely

$$m = \frac{( c ( {0}_{} + N {1}_{} ) mod {N}^{2} ) - 1}{N} .$$

While this embodiment is efficient when it comes to bandwidth as the blind Paillier decryption method illustrated in FIG. 1, it is noted that the method illustrated in FIG. 1 has the advantage that the calculations of the user device are simpler since in the on-line phase the user device has just to evaluate a mere addition modulo N to obtain m.

In a variant of the methods illustrated in FIGS. 1 and 2, c₀ is obtained by reduction modulo a positive integer multiple (greater than 1) of the modulus N, for example 2N, which just requires the transmission of one more bit.

It will be appreciated that the blind-decryption protocol of the present disclosure is bandwidth optimal. This is particularly advantageous when a large number of Paillier ciphertexts are exchanged, which for example is the case in the privacy-preserving recommendation system described by Nikolaenko, Weinsberg, Ioannidis, Joye, Boneh and Taft [Valeria Nikolaenko, Udi Weinsberg, Stratis Ioannidis, Marc Joye, Dan Boneh, and Nina Taft. Privacy-preserving ridge regression on hundreds of millions of records. In 34th IEEE Symposium on Security and Privacy (S&P 2013), pp. 334-348, IEEE Computer Society, 2013]

Each feature disclosed in the description and (where appropriate) the claims and drawings may be provided independently or in any appropriate combination. Features described as being implemented in hardware may also be implemented in software, and vice versa. Reference numerals appearing in the claims are by way of illustration only and shall have no limiting effect on the scope of the claims.

1. A cryptographic device comprising:
an interface configured to send a blinded Paillier ciphertext c₀ to a decryption device and to receive a return value μ₁ from the decryption device; and
a processor configured to:
obtain a Paillier ciphertext c, the Paillier ciphertext c having been generated using an encryption method with a public key comprising a modulus N being the product of at least two primes p, q;
calculate the blinded Paillier ciphertext c₀ by taking the Paillier ciphertext c modulo a value based on the modulus N;
calculate a first value [symbol] ₀ through a calculation involving an inverse of the blinded Paillier ciphertext c₀ modulo a value based on the modulus N;
generate a blinded plaintext m* through a calculation involving a multiplication of the Paillier ciphertext c and the first value [symbol] ₀; and
generate a plaintext m through a calculation involving an addition of the blinded plaintext m* and the return value μ₁ modulo a value based on the modulus N.

2. A decryption device comprising:
an interface configured to receive a blinded Paillier ciphertext c₀ from a cryptographic device and to send a return value μ₁ to the cryptographic device; and
a processor configured to:
calculate a first key λ₀ through a calculation involving an inversion of a modulus N modulo a value based on a private key λ;
calculate a second value ρ₀ through a calculation involving the blinded Paillier ciphertext c₀ to the power of the first key λ₀ modulo a value based on the modulus N;
calculate a third value [symbol] through a calculation involving the second value ρ₀ to the power of the modulus N modulo a value based on the modulus N; and
calculate the return value μ₁ through a calculation involving a multiplication of the third value [symbol] and the blinded Paillier ciphertext c₀.

3. A cryptographic device comprising:
an interface configured to send a blinded Paillier ciphertext c₀ to a decryption device and to receive at least one return value from the decryption device; and
a processor configured to:
obtain a Paillier ciphertext c, the Paillier ciphertext c having been generated using an encryption method with a public key comprising a modulus N being the product of at least two primes p, q;
calculate the blinded Paillier ciphertext c₀ by taking the Paillier ciphertext c modulo a value based on the modulus N;
calculate a first value [symbol] ₀ through a calculation involving an inverse of the blinded Paillier ciphertext c₀ modulo a value based on the modulus N;
obtain a third value [symbol] from the at least one return value;
calculate an exponent value (1+N)^{m} modulo a value based on the modulus N through a calculation involving a multiplication between the Paillier ciphertext c and the third value [symbol] ; and
obtain a plaintext m from the exponent value (1+N)^{m} modulo a value based on the modulus N using inductive decryption.

4. A decryption device comprising:
an interface configured to receive a blinded Paillier ciphertext c₀ from a cryptographic device and to send at least one return value to the cryptographic device; and
a processor configured to:
calculate a first key λ₀ through a calculation involving an inversion of a modulus N to the power of a value s having been used to generate a Paillier ciphertext c from which the blinded Paillier ciphertext c₀ was calculated, the inversion being taken modulo a value based on a private key λ;
calculate a second value ρ₀ through a calculation involving the blinded Paillier ciphertext c₀ to the power of the first key λ₀ modulo a value based on the modulus N;
calculate a third value [symbol] through a calculation involving the second value ρ₀ to the power of the modulus N to the power of the value s modulo a value based on the modulus N and the value s, the third value; and
obtain the at least one return value, the return value being equal to the third value [symbol] or a value based on the third value [symbol] minus a first component [symbol] ₀ and the modulus N, the first component [symbol] ₀ being equal to a value obtained by a calculation involving an inverse of the blinded Paillier ciphertext c₀ modulo a value based on the modulus N.

5. A cryptographic method for generating a plaintext m for a Paillier ciphertext c, the method comprising, in a device comprising a processor:
obtaining a Paillier ciphertext c, the Paillier ciphertext c having been generated using an encryption method with a public key comprising a modulus N being the product of at least two primes p, q;
calculating a blinded Paillier ciphertext c₀ by taking the Paillier ciphertext c modulo a value based on the modulus N;
calculating a first value [symbol] ₀ through a calculation involving an inverse of the blinded Paillier ciphertext c₀ modulo a value based on the modulus N;
generating a blinded plaintext m* through a calculation involving a multiplication of the Paillier ciphertext c and the first value [symbol] ₀; and
generating the plaintext m through a calculation involving an addition of the blinded plaintext m* and a return value μ₁ modulo a value based on the modulus N.

6. A cryptographic method for blind decryption of a blinded Paillier ciphertext c₀, the method comprising, in a device comprising a processor
obtaining a first key λ₀, the first key λ₀ having been generated through a calculation involving an inversion of a modulus N modulo a value based on a private key A;
calculating a second value ρ₀ through a calculation involving the blinded Paillier ciphertext c₀ to the power of the first key λ₀ modulo a value based on the modulus N;
calculating a third value [symbol] through a calculation involving the second value ρ₀ to the power of the modulus N modulo a value based on the modulus N;
calculating a return value μ₁ through a calculation involving a multiplication of the third value [symbol] and the blinded Paillier ciphertext c₀; and
outputting the return value μ₁.

7. A cryptographic method for generating a plaintext m for a Paillier ciphertext c, the method comprising, in a device comprising a processor:
obtaining the Paillier ciphertext c, the Paillier ciphertext c having been generated using an encryption method with a public key comprising a modulus N being the product of at least two primes p, q;
calculating the blinded Paillier ciphertext c₀ by taking the Paillier ciphertext c modulo a value based on the modulus N;
calculating a first value [symbol] ₀ through a calculation involving an inverse of the blinded Paillier ciphertext c₀ modulo a value based on the modulus N;
obtaining a third value [symbol] from the at least one return value;
calculating an exponent value (1+N)^{m} modulo a value based on the modulus N through a calculation involving a multiplication between the Paillier ciphertext c and the third value [symbol] ; and
obtaining the plaintext m from the exponent value (1+N)^{m} modulo a value based on the modulus N using inductive decryption.

8. A cryptographic method for blind decryption of a blinded Paillier ciphertext c₀, the method comprising, in a device comprising a processor:
obtaining a first key λ₀, the first key λ₀ having been generated through a calculation involving an inversion of a modulus N to the power of a value s having been used to generate a Paillier ciphertext c from which the blinded Paillier ciphertext c₀ was calculated, the inversion being taken modulo a value based on a private key λ;
calculating a second value ρ₀ through a calculation involving the blinded Paillier ciphertext c₀ to the power of the first key λ₀ modulo a value based on the modulus N;
calculating a third value [symbol] through a calculation involving the second value ρ₀ to the power of the modulus N to the power of the value s modulo a value based on the modulus N and the value s;
obtaining the at least one return value, the return value being equal to the third value [symbol] or a value based on the third value [symbol] minus a first component [symbol] ₀ and the modulus N, the first component [symbol] ₀ being equal to a value obtained by a calculation involving an inverse of the blinded Paillier ciphertext c₀ modulo a value based on the modulus N; and
outputting the at least one return value.
